(19) United States
(12) Patent Application Publication
(10) Pub. No.: US 2024/0242116 A1
(43) Pub. Date: Jul. 18, 2024

(54) SYSTEMS AND TECHNIQUES FOR MEASURING MODEL SENSITIVITY AND FEATURE IMPORTANCE OF MACHINE LEARNING MODELS

(71) Applicant: GM Cruise Holdings LLC, San Francisco, CA (US)

(72) Inventors: Akshay Rangesh, Mountain View, CA (US); Chingiz Tairbekov, San Francisco, CA (US)

(21) Appl. No.: 18/156,321

(22) Filed: Jan. 18, 2023

(51) Int. Cl. G06N 20/00

(52) U.S. Cl. CPC G06N 20/00

(57) ABSTRACT

The disclosed technology provides solutions for calculating a sensitivity metric and determining, based on the sensitivity metric, whether to continue training the machine learning model. A method of the disclosed technology can include steps for determining a first value of a first output parameter during a first training iteration of a machine learning model; calculating a first sensitivity metric based on the first value of the first output parameter and one or more values of a first input parameter that are provided to the machine learning model during the first training iteration, wherein the first sensitivity metric is indicative of a rate of change of the first output parameter relative to the first input parameter; and determining, based on the first sensitivity metric, whether to continue training of the machine learning model. Systems and machine-readable media are also provided.

### BACKGROUND

### 1. Technical Field

The disclosed technology provides solutions for improving machine learning models and in particular, provides systems and techniques for calculating a metric that determines the sensitivity of machine learning models.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras, radars, and/or Light Detection and Ranging (LiDAR) sensors disposed on the AV. In some instances, the collected data can be used by machine learning models that operate on the AV to perform tasks relating to routing, planning and obstacle avoidance.

### BRIEF DESCRIPTION OF THE DRAWINGS

Certain features of the subject technology are set forth in the appended claims. However, the accompanying drawings, which are included to provide further understanding, illustrate disclosed aspects and together with the description explain the principles of the subject technology. In the drawings:

FIG. 1 illustrates an example system environment that can be used to facilitate AV dispatch and operations, according to some aspects of the disclosed technology.

FIG. 2 illustrates an example architecture of a deep-learning neural network that can be trained based on a sensitivity metric, according to some aspects of the disclosed technology.

FIG. 3 illustrates an example scenario for employing an occlusion model of an AV that can be trained and/or or modified based on a sensitivity metric, according to some aspects of the disclosed technology.

FIG. 4 illustrates a diagram of an example system for determining a model sensitivity metric, according to some aspects of the disclosed technology.

FIGS. 5A-5C illustrate example graphs of sensitivity metrics plotted against training time, according to some aspects of the disclosed technology.

FIG. 6 illustrates a flow chart for training and/or adjusting a machine learning model based a sensitivity metric, according to some aspects of the disclosed technology.

FIG. 7 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring certain concepts.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As AV technologies continue to advance, one way to improve transportation efficiency and safety is to improve the training of the machine learning models used when operating the AV. As discussed in more detail below, the machine learning models used by the AV can be trained, evaluated, refined, and deployed based on one or more model sensitivity parameters. For example, during model training, it is not only desirable to avoid the problem of overfitting, but also to avoid the problem of oversensitivity.

Overfitting is a problem that can be encountered when training machine learning models wherein the machine learning model produces correct outputs based on inputs from a training data set, but as the model is continually trained with more training data, the outputs produced from inputting evaluation data sets begin to deteriorate. That is, the model becomes overtrained so that it becomes too much in tune with the input data, and when data that is different from the training data is input (e.g., evaluation data, real-world data, etc.), the model produces incorrect results. One method to avoid overfitting includes analyzing training/validation loss curves to determine when the model has converged. Training can be stopped at the point after which the validation loss increases despite the training loss decreasing further. However, although monitoring training/validation loss curves can prevent overfitting, it fails to address the other problem of oversensitivity.

Oversensitivity is a problem encountered when training machine learning models wherein the outputs of the model change notably in response to relatively small changes in the inputs. That is, model sensitivity is a measure of model robustness to reasonably small input perturbations. Unlike overfitting, where the outputs become consistently erroneous regardless of changes to the input data sets, oversensitivity occurs when slight changes to the input data set cause notable changes the outputs. Therefore, oversensitivity can be considered an orthogonal problem in relation to overfitting that can be addressed separately. In some cases, oversensitivity of a machine learning model can result in unpredictability that may hinder deployment of the model in a real-world environment. For example, the inputs processed by a machine learning model at inference time can have noise and/or slight deviations as compared to the training data used to train the model. Therefore, in an oversensitive model, this noise and/or slight deviations in the data can produce erroneous outputs that can result in inaccurate predictions that may present passenger comfort issues and/or safety hazards, among other concerns.

To address oversensitivity, a model sensitivity metric can be analyzed during model training to determine the optimal time to stop training a model to avoid (or reduce) oversensitivity. As discussed in more detail below, this sensitivity metric can measure the rate of change of one or more model outputs relative to one or more model inputs. In some aspects, the sensitivity metric can be based on input-output Jacobian norms that can be calculated and tracked to determine when to stop training the model. In some cases, the sensitivity metric can be analyzed separately from the traditional loss curves that can be analyzed to prevent overfitting, and therefore both overfitting and oversensitivity can be considered when determining when to stop model training for best results. Additionally, as discussed in more detail below, the model sensitivity metric can be used to help determine which features of the model are most sensitive to fluctuations in the input data and therefore can be considered more important features. In some aspects, the model sensitivity metric may also be used to optimize a machine learning model such as through feature selection. For instance, the model sensitivity metric(s) can be used to reduce the number of inputs while achieving the same or similar performance.

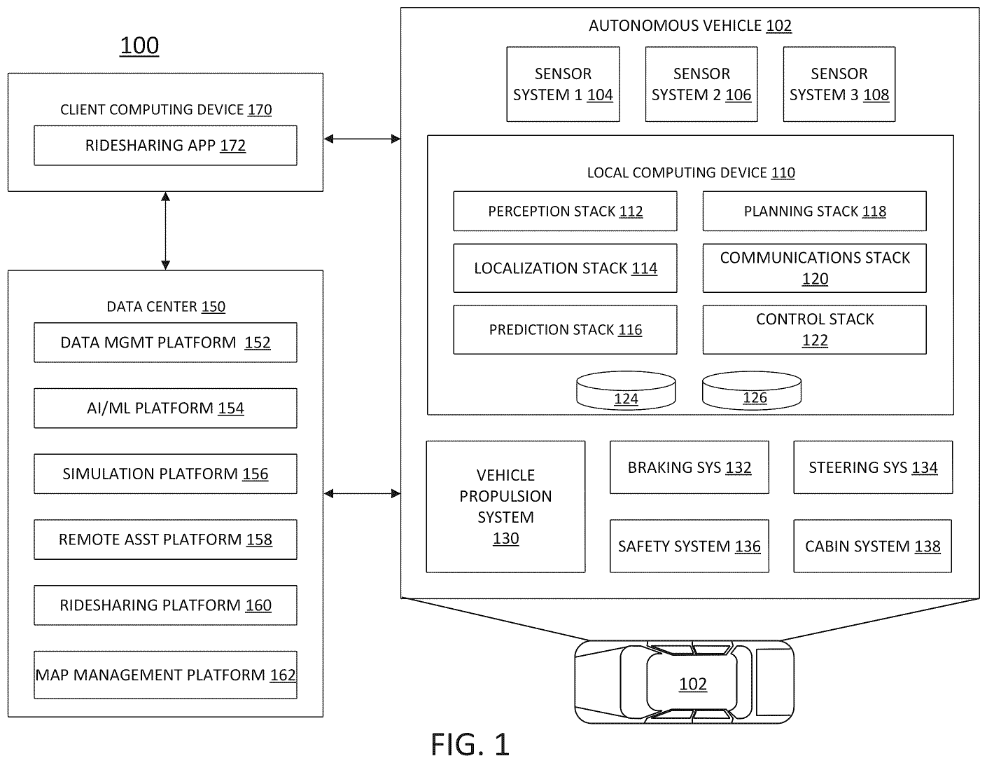

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), optical sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, AV 102 can compare sensor data captured in real-time by sensor systems 104-108 to data in HD geospatial database 126 to determine its precise (e.g., accurate to the order of a few centimeters or less) position and orientation. AV 102 can focus its search based on sensor data from one or more first sensor systems (e.g., GPS) by matching sensor data from one or more second sensor systems (e.g., LIDAR). If the mapping and localization information from one system is unavailable, AV 102 can use mapping and localization information from a redundant system and/or from remote data sources.

Prediction stack 116 can receive information from localization stack 114 and objects identified by perception stack 112 and predict a future path for the objects. In some embodiments, prediction stack 116 can output several likely paths that an object is predicted to take along with a probability associated with each path. For each predicted path, prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate AV 102 safely and efficiently in its environment. For example, planning stack 118 can receive the location, speed, and direction of AV 102, geospatial data, data regarding objects sharing the road with AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. Planning stack 118 can determine multiple sets of one or more mechanical operations that AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. Control stack 122 can receive sensor signals from the sensor systems 104-108 as well as communicate with other stacks or components of the local computing device 110 or a remote system (e.g., the data center 150) to effectuate operation of AV 102. For example, control stack 122 can implement the final path or actions from the multiple paths or actions provided by planning stack 118. This can involve turning the routes and decisions from planning stack 118 into commands for the actuators that control the AV's steering, throttle, brake, and drive unit.

Communications stack 120 can transmit and receive signals between the various stacks and other components of AV 102 and between AV 102, data center 150, client computing device 170, and other remote systems. Communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 124 can store raw AV data generated by the sensor systems 104-108, stacks 112-122, and other components of AV 102 and/or data received by AV 102 from remote systems (e.g., data center 150, client computing device 170, etc.). In some embodiments, the raw AV data can include HD LIDAR point cloud data, image data, RADAR data, GPS data, and other sensor data that data center 150 can use for creating or updating AV geospatial data or for creating simulations of situations encountered by AV 102 for future testing or training of various machine learning algorithms that are incorporated in local computing device 110.

Data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. Data center 150 can include one or more computing devices remote to local computing device 110 for managing a fleet of AVs and AV-related services. For example, in addition to managing AV 102, data center 150 may also support a ridesharing service, a delivery service, a remote/roadside assistance service, street services (e.g., street mapping, street patrol, street cleaning, street metering, parking reservation, etc.), and the like.

Data center 150 can send and receive various signals to and from AV 102 and client computing device 170. These signals can include sensor data captured by the sensor systems 104-108, roadside assistance requests, software updates, ridesharing pick-up and drop-off instructions, and so forth. In this example, data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

AI/ML platform 154 can provide the infrastructure for training and evaluating machine learning algorithms for operating AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for AV 102, remote assistance platform 158, ridesharing platform 160, map management platform 162, and other platforms and systems. The simulation platform 156 can replicate a variety of driving environments and/or reproduce real-world scenarios from data captured by AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of data center 150, remote assistance platform 158 can prepare instructions for one or more stacks or other components of AV 102.

Ridesharing platform 160 can interact with a customer of a ridesharing service via a ridesharing application 172 executing on client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing ridesharing application 172. Client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of data center 150. For example, the AI/ML platform 154 may incorporate the map viewing services for visualizing the effectiveness of various object detection or object classification models, simulation platform 156 may incorporate the map viewing services for recreating and visualizing certain driving scenarios, remote assistance platform 158 may incorporate the map viewing services for replaying traffic incidents to facilitate and coordinate aid, ridesharing platform 160 may incorporate the map viewing services into client application 172 to enable passengers to view AV 102 in transit en route to a pick-up or drop-off location, and so on.

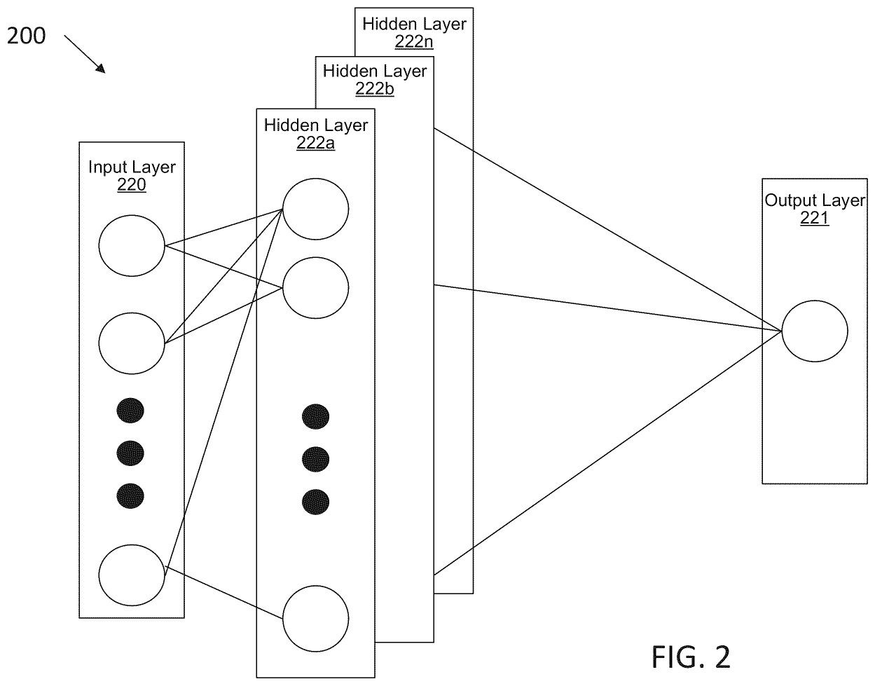

FIG. 2 is an illustrative example of a deep learning neural network 200 that can be trained and/or optimized based on a sensitivity metric. An input layer 220 includes input data. The neural network 200 includes multiple hidden layers 222a, 222b, through 222n. The hidden layers 222a, 222b, through 222n include “n” number of hidden layers, where “n” is an integer greater than or equal to one. The number of hidden layers can be made to include as many layers as needed for the given application. The neural network 200 further includes an output layer 221 that provides an output resulting from the processing performed by the hidden layers 222a, 222b, through 222n.

The neural network 200 is a multi-layer neural network of interconnected nodes. Each node can represent a piece of information. Information associated with the nodes is shared among the different layers and each layer retains information as information is processed. In some cases, the neural network 200 can include a feed-forward network, in which case there are no feedback connections where outputs of the network are fed back into itself. In some cases, the neural network 200 can include a recurrent neural network, which can have loops that allow information to be carried across nodes while reading in input.

Information can be exchanged between nodes through node-to-node interconnections between the various layers. Nodes of the input layer 220 can activate a set of nodes in the first hidden layer 222a. For example, as shown, each of the input nodes of the input layer 220 is connected to each of the nodes of the first hidden layer 222a. The nodes of the first hidden layer 222a can transform the information of each input node by applying activation functions to the input node information. The information derived from the transformation can then be passed to and can activate the nodes of the next hidden layer 222b, which can perform their own designated functions. Example functions include convolutional, up-sampling, data transformation, and/or any other suitable functions. The output of the hidden layer 222b can then activate nodes of the next hidden layer, and so on. The output of the last hidden layer 222n can activate one or more nodes of the output layer 221, at which an output is provided. In some cases, while nodes (e.g., node 226) in the neural network 200 are shown as having multiple output lines, a node can have a single output and all lines shown as being output from a node represent the same output value.

In some cases, each node or interconnection between nodes can have a weight that is a set of parameters derived from the training of the neural network 200. Once the neural network 200 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 200 to be adaptive to inputs and able to learn as more and more data is processed.

The neural network 200 is pre-trained to process the features from the data in the input layer 220 using the different hidden layers 222a, 222b, through 222n in order to provide the output through the output layer 221. In some cases, the neural network 200 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training data until the neural network 200 is trained well enough so that the weights of the layers are accurately tuned.

A loss function can be used to analyze error in the output. Any suitable loss function definition can be used, such as a Cross-Entropy loss. Another example of a loss function includes the mean squared error (MSE), defined as E_total=Σ(½(target−output)²). The loss can be set to be equal to the value of E_total. The goal of training is to minimize the amount of loss so that the predicted output is the same as the training label. The neural network 200 can perform a backward pass by determining which inputs (weights) most contributed to the loss of the network, and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=w_i−η dL/dW, where w denotes a weight, wi denotes the initial weight, and η denotes a learning rate. The learning rate can be set to any suitable value, with a high learning rate including larger weight updates and a lower value indicating smaller weight updates.

The neural network 200 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 200 can include any other deep network other than a CNN, such as an autoencoder, a deep belief nets (DBNs), a Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

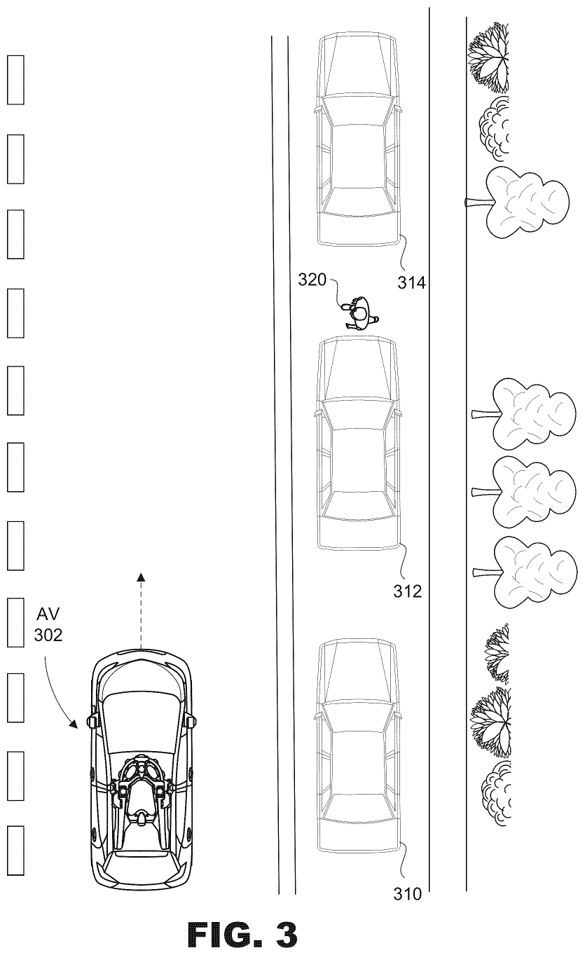

FIG. 3 illustrates an example scenario for employing an occlusion machine learning model of an AV 302 that can be trained and/or optimized using a model sensitivity metric, according to some aspects of the disclosed technology. As discussed above, the AV 302's local computing device 110 can include a perception stack 112 that can enable the AV 302 to detect and classify objects and determine their current locations, speeds, directions, and the like. In addition, the perception stack 112 can determine the free space around the AV 302 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some examples, the perception stack 112 can determine areas that may be obscured or blocked from view by an occlusion using an occlusion machine learning model.

FIG. 3 illustrates AV 302 traveling on a roadway in the direction indicated by the dotted arrow. On the right side of the street, vehicle 310, vehicle 312, and vehicle 314 are parallel parked, and person 320 is standing between vehicle 312 and vehicle 314. As discussed above, in some examples, sensors mounted about AV 302 can receive data related to the environment around AV 302 and communicate this data to the perception stack to enable the AV 302 to “see” the environment. However, in some examples an object in AV 302's environment can be occluded (i.e., blocked) from the field of view of the sensors mounted about AV 302. For example, as shown in FIG. 3, person 320 can be occluded from the field of view of the sensors mounted on AV 302 by at least parked vehicle 312.

Consequently, in some examples, AV 302 may not be aware of objects that may be present within an occluded region (e.g., AV 302 may not be aware that person 320 is standing behind parked vehicle 312). Therefore, in some examples, an occlusion machine learning model can be included in AV 302's perception stack. In some examples, the occlusion machine learning model can predict when an object may be occluding another object in AV 302's environment and further predict when AV 302 has moved sufficiently that no objects are occluded by that specific occlusion. In some cases, the occlusion machine learning model can calculate the distance between AV 302 and an occluded region (e.g., the occlusion model can determine the dissipation distance from the current AV position to the occlusion region).

In some examples, an occlusion machine learning model can receive multiple inputs in order to identify an occluded region and/or a distance between AV 302 and an occluded region. For example, the occlusion machine learning model can use inputs such as a sensed occlusion's height (e.g., the height of vehicle 312), a classification of an object causing an occlusion (e.g., van, truck, pedestrian, etc.), and/or a heading of an object causing an occlusion. However, these examples are not limiting, and in some examples, there can be several more features tracked by the occlusion machine learning model. While an occlusion machine learning model can be useful in identifying and assisting the AV 302 in identifying and handling occlusions, the model can suffer degraded performance due to oversensitivity. That is, overtraining of the occlusion model may result in oversensitivity which causes predictions (e.g., outputs) to unexpectedly shift based on small changes in one or more inputs.

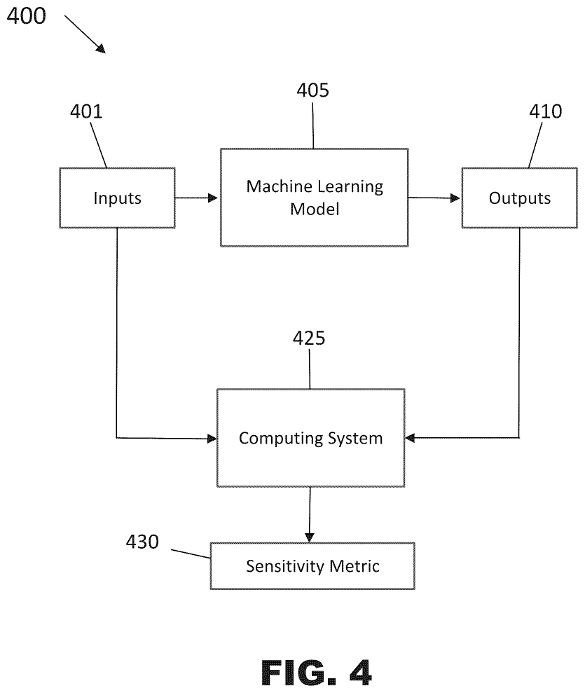

As discussed above, in some examples, overfitting can be avoided by analyzing training/validation loss curves to determine when the model has converged. However, this method does not address the problem of oversensitivity. Therefore, in order to overcome the problem of oversensitivity, a model sensitivity metric can be calculated, tracked, and analyzed during model training to determine the optimal time to stop training a model to avoid (or reduce) oversensitivity. The details of this model sensitivity metric will be discussed in more detail with regard to FIG. 4. While the occlusion model is described herein as an example for determining model sensitivity, those that are skilled in the art will recognize that the present technology is not limited to any particular machine learning model and that the systems and techniques described herein can be applied to any machine learning model.

In some aspects, model sensitivity can be a measure of machine learning model's robustness to reasonably small input perturbations. Therefore, if a machine learning model's predictions change greatly (e.g., above a threshold value) due to small perturbations in its inputs, it can be considered to be oversensitive. In some examples, an oversensitive model is not desirable as it indicates that a spiky function has been learned, which can lead to unreliable predictions. On the other hand, an insensitive model is undesirable because the model will produces similar outputs regardless of the inputs.

FIG. 4 illustrates a diagram of an example system 400 for determining a model sensitivity metric 430. As shown in FIG. 4, machine learning model 405 can receive inputs 401 and produce outputs 410 (e.g., predictions). In some cases, machine learning model 405 can be an occlusion machine learning model (as discussed above) or can alternatively be any other type of machine learning model. In some examples, machine learning model 405 can be trained by inputting batches of training data to train the model. However, as discussed above, in some examples, inputting too much training data can lead to model oversensitivity resulting in unreliable outputs. In some cases, oversensitivity can make a model too unpredictable to be deployed on the road in a real-world environment.

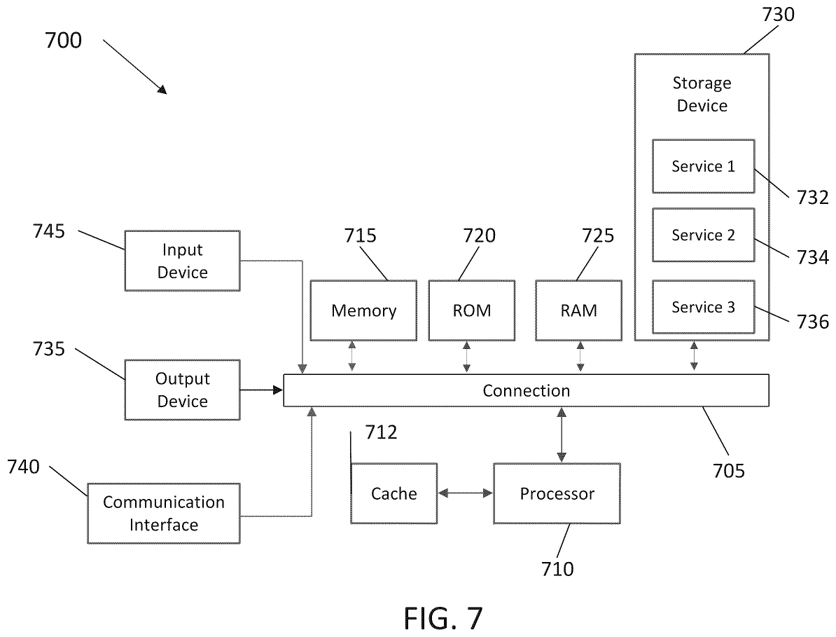

To address oversensitivity, a model sensitivity metric 430 can be determined using, for example, a computing system 425 during model training. In some aspects, computing system 425 may include one or more components as described in connection with computing system 700 in FIG. 7 below. As shown in FIG. 4, computing system 425 can receive the batch data inputs 401 as well as the batch data outputs 410. In some examples, computing system 425 can use a Frobenius norm of an input-output Jacobian matrix for each input feature (averaged over a mini-batch of data) to indicate the sensitivity of the model's output to small changes in a given input feature. In some examples, each row of the input-output Jacobian matrix can correspond to an output, and each column can correspond to an input. In some examples, computing system 425 can calculate the instantaneous gradient for each input of the input-output Jacobian matrix and subsequently take the Frobenius norm to produce a single value. In some examples, the computing system 425 can then calculate the average of each of the calculated Frobenius norms of the batch of input data to produce a single value that indicates the sensitivity of the model for a single feature (e.g., input) across all of the batches of inputs.

The input-output Jacobian matrix contains partial derivatives of each output variable with respect to each input variable, each of which indicates how fast the output changes in the immediate vicinity of the input. In some examples, the Frobenius norm is calculated for each input-output pair (averaged across a mini-batch) of the Jacobian matrix, which is subsequently used as an indicator of the model's sensitivity for that input-output pair. In some examples, computing system 425 can employ this method during model training so that the corresponding Jacobian norms can be tracked along with the loss curves.

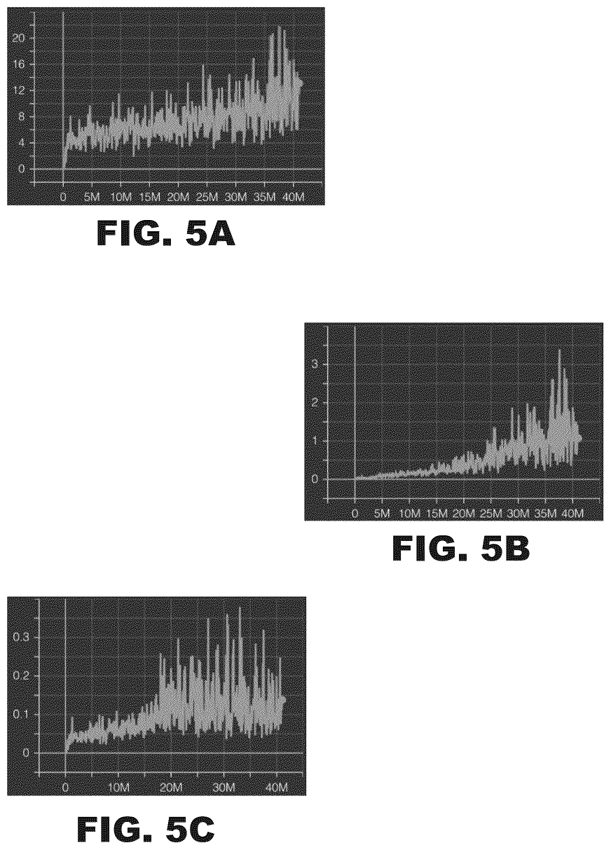

In some examples, the sensitivity metric 430 for each input feature can be plotted as model sensitivity plots as illustrated in FIGS. 5A-5C. For instance, FIG. 5A illustrates an example graph of the occlusion model sensitivity based on the height input to the occlusion machine learning model. In FIG. 5A, the y-axis corresponds to the change in the prediction output (e.g., distance to occlusion dissipation) relative to a change in the occlusion height input of the machine learning model, and the x-axis corresponds to the number of training iterations. In some examples, the distance to occlusion dissipation can be the distance between AV 302 and the perceived occlusion at which point it is predicted that the occlusion will cease to exist. For instance, at approximately 5 million training iterations, FIG. 5A illustrates that a unit change in the occlusion height input will result in approximately 4 meter change in the predicted output.

FIG. 5B illustrates an example graph of the occlusion model sensitivity based on the occlusion classification input to the occlusion machine learning model. In FIG. 5B, the y-axis corresponds to the change in the prediction output (e.g., distance to occlusion dissipation) relative to a change in the occlusion classification, and the x-axis corresponds to the number of training iterations. FIG. 5B illustrates that the sensitivity to the occlusion classification input increases significantly between 25 million training cycles and 40 million training cycles.

FIG. 5C illustrates an example graph of the occlusion model sensitivity based on the occlusion heading input to the occlusion machine learning model. In FIG. 5C, the y-axis corresponds to the change in the prediction output (e.g., distance to occlusion dissipation) relative to a change in the occlusion heading, and the x-axis corresponds to the number of training iterations. FIG. 5C illustrates that the sensitivity to the occlusion classification input increases significantly after ˜ 15 million training cycles, however the absolute value of the change in the model prediction is still relatively small (e.g., maximum of approximately 0.35 meters).

In some examples, the graphs and/or plots (e.g., FIGS. 5A, 5B, and/or 5C) can be used to track the various sensitivity metrics 430 during model training to determine the optimal time to stop training to prevent oversensitivity. Additionally, in some examples, these plots can also be used to determine and/or identify features (e.g., inputs) that have the greatest impact on model predictions.

For example, the model sensitivity plot illustrated in FIG. 5A (e.g., occlusion height) can demonstrate how these model sensitivity plots can be used to determine the optimal time to stop training to prevent oversensitivity. In this example, the model prediction (y-axis) is shown fluctuating between about 2 and 12 from 0 to about 20 million training iterations (x-axis). In some examples, this fluctuation can be considered acceptable. However, at a point after about 20 million training iterations, the model prediction (y-axis) begins fluctuating much more until it is fluctuating between about 6 and 22 by the time the training reaches about 40 million iterations. In some examples, this fluctuation is not acceptable. Therefore, based on the plot illustrated in FIG. 5A, in some examples, it can be determined that the optimal time to stop the training to avoid oversensitivity can be somewhere between about 10 million and 20 million steps.

The model sensitivity plot illustrated in FIG. 5B (e.g., occlusion classification) can provide another example of how these model sensitivity plots can be used to determine the optimal time to stop training to prevent oversensitivity. In this example, the model prediction (y-axis) is shown fluctuating between about 0 and 1 from 0 to about 25 million training iterations (x-axis). In some examples, this fluctuation can be considered acceptable. However, at a point after about 25 million steps, the model prediction (y-axis) fluctuates more until it is fluctuating between about 0.5 m and 3.5 m by the time the training reaches about 40 million training iterations. In some examples, this fluctuation may not be acceptable. Although, it can also be important to consider that a fluctuation between 0.5 and 3.5 is still a much smaller fluctuation than the fluctuation between 6 and 22 that occurs in the model sensitivity plot illustrated in FIG. 5A (e.g., based on occlusion height). Therefore, based on the plots illustrated in both FIGS. 5A and 5B, it can be determined that the optimal time to stop the training to avoid oversensitivity can be somewhere between about 10 million and 20 million steps.

The model sensitivity plot illustrated in FIG. 5C (i.e., occlusion heading) can demonstrate how these model sensitivity plots can be used as an indicator of feature importance (assuming all features are roughly the same scale). For example, the model prediction (y-axis) is shown fluctuating only between about 0.05 m and 0.35 m in the range of 25 million to 35 million training iterations. In some examples, a relatively low variability in the model prediction (e.g., 0.05 m-0.35 m) may indicate that the model largely ignores the input and thus may not be impacted by its removal. Alternatively, in some examples, features (e.g., inputs) that have relatively high model sensitivity metric values have a larger impact and can therefore be considered more important features.

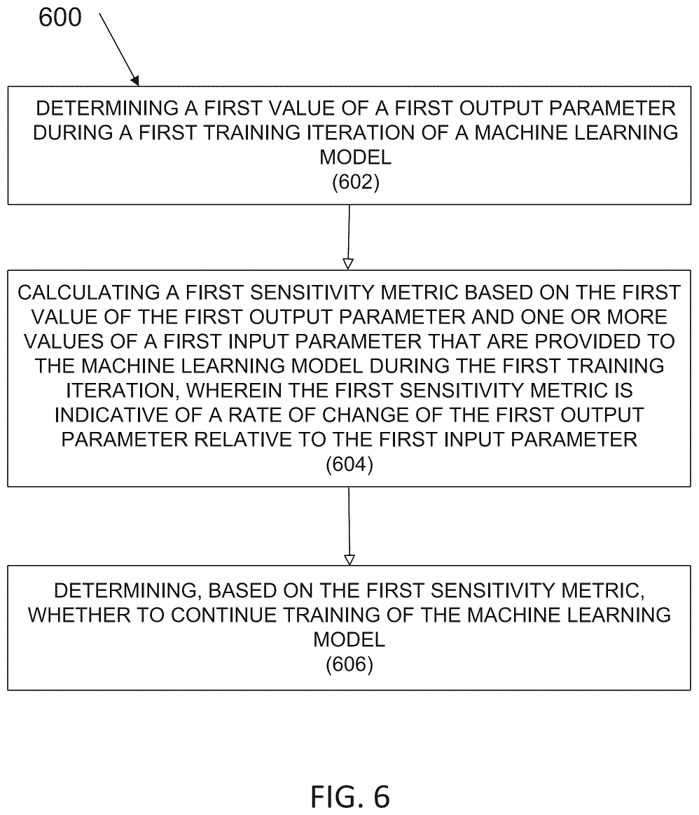

FIG. 6 illustrates a process 600 for training and/or adjusting a machine learning model based a sensitivity metric, according to some aspects of the disclosed technology. At block 602, the process 600 can include determining a first value of a first output parameter (e.g., outputs 410) during a first training iteration of a machine learning model (e.g., machine learning model 405). For example, machine learning model 405 can receive inputs 401 (e.g., training data) and subsequently produce outputs 410.

At block 604, the process 600 can include calculating a first sensitivity metric (e.g., model sensitivity metric 430) based on the first value of the first output parameter (e.g., outputs 410) and one or more values of a first input parameter (e.g., inputs 401) that are provided to the machine learning model (e.g., machine learning model 405) during the first training iteration, wherein the first sensitivity metric (e.g., model sensitivity metric 430) is indicative of a rate of change of the first output parameter (e.g., outputs 410) relative to the first input parameter (e.g., inputs 401). For example, the model sensitivity metric 430 can be calculated using, for example, a computer system 425 during model training.

As shown in FIG. 4, computing system 425 can receive the batch data inputs 401 as well as the batch data outputs 410. In some examples, computing system 425 can use a Frobenius norm of an input-output Jacobian matrix for each input feature (averaged over a mini-batch of data) to indicate the sensitivity of the model's output to small changes in a given input feature. In some examples, computing system 425 can calculate the instantaneous gradient for each input of the input-output Jacobian matrix and subsequently take the Frobenius norm to produce a single value. The input-output Jacobian matrix contains partial derivatives of each output variable with respect to each input variable, each of which indicates how fast the output changes in the immediate vicinity of the input.

Alternatively, the method can further include calculating a plurality of sensitivity metrics that are each indicative of a rate of change of an output parameter relative to an input parameter; and identifying, based on the plurality of sensitivity metrics, one or more critical input parameters. In some examples, as discussed above, input parameters that produce relatively high model sensitivity metric values have a larger impact on the predictions and can therefore be considered more important features. Further, the method can include identifying, based on the plurality of sensitivity metrics, at least one negligible input, and simplifying the machine learning model by removing the at least one negligible input.

At block 606, the process 600 can include determining, based on the first sensitivity metric (e.g., model sensitivity metric 430), whether to continue training of the machine learning model (e.g., machine learning model 405). For example, as discussed above, the plots illustrated in FIGS. 5A-5C can be used to track the various sensitivity metrics 430 during model training to determine the optimal time to stop training to prevent oversensitivity. Specifically, the fluctuations of the model predictions (y-axis) over time (x-axis) can be analyzed to find the point (e.g., number of training iterations) where the machine learning model has an optimized sensitivity. In some examples, the sensitivity of the machine learning model can be based on the absolute value of the sensitivity metric (e.g., raw sensitivity value). In some cases, the sensitivity of the machine learning model can be based on the fluctuations or swings in the prediction (e.g., based on change to input). In some aspects, the sensitivity of the machine learning model can be based on a change or deviation in the sensitivity (e.g., standard deviation of the sensitivity through training).

In some examples, determining, based on the first sensitivity metric (e.g., model sensitivity metric 430), whether to continue training of the machine learning model (e.g., machine learning model 405) can include determining that the first sensitivity metric (e.g., model sensitivity metric 430) is greater than a threshold sensitivity value; and in response, determining to end the training of the machine learning model (e.g., machine learning model 405). In some examples, determining, based on the first sensitivity metric (e.g., model sensitivity metric 430), whether to continue training of the machine learning model (e.g., machine learning model 405) can include multiple iterations. For example, the method can further include determining a second value of the first output parameter during a second training iteration of the machine learning model; calculating a second sensitivity metric based on the second value of the first output parameter and the one or more values of the first input parameter that are provided to the machine learning model during the second training iteration; and determining, based on the first sensitivity metric and the second sensitivity metric, whether to continue the training of the machine learning model.

Alternatively, determining whether to continue training of the machine learning model (e.g., machine learning model 405) can also include determining that a deviation between the first sensitivity metric and the second sensitivity metric is greater than a threshold deviation value; and in response, determining to end the training of the machine learning model.

FIG. 7 illustrates an example apparatus (e.g., a processor-based system) with which some aspects of the subject technology can be implemented. For example, processor-based system 700 can be any computing device making up internal computing system 110, remote computing system 150, a passenger device executing the rideshare app 170, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

Computing system 700 can be (or may include) a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random-access memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L6), resistive random-access memory (RRAM/ReRAM), phase change memory (PCM), spin transfer torque RAM (STT-RAM), another memory chip or cartridge, and/or a combination thereof.

Storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

Aspect 1. A method comprising: determining a first value of a first output parameter during a first training iteration of a machine learning model; calculating a first sensitivity metric based on the first value of the first output parameter and one or more values of a first input parameter that are provided to the machine learning model during the first training iteration, wherein the first sensitivity metric is indicative of a rate of change of the first output parameter relative to the first input parameter; and determining, based on the first sensitivity metric, whether to continue training of the machine learning model.

Aspect 2. The method of Aspect 1, further comprising: determining that the first sensitivity metric is greater than a threshold sensitivity value; and in response, determining to end the training of the machine learning model.

Aspect 3. The method of Aspect 1 or 2, further comprising: determining a second value of the first output parameter during a second training iteration of the machine learning model; calculating a second sensitivity metric based on the second value of the first output parameter and the one or more values of the first input parameter that are provided to the machine learning model during the second training iteration; and determining, based on the first sensitivity metric and the second sensitivity metric, whether to continue the training of the machine learning model.

Aspect 4. The method of Aspect 3, further comprising: determining that a deviation between the first sensitivity metric and the second sensitivity metric is greater than a threshold deviation value; and in response, determining to end the training of the machine learning model.

Aspect 5. The method of any of Aspects 1 to 4, wherein calculating the first sensitivity metric comprises: calculating a Jacobian matrix based on the first value of the first output parameter and the one or more values of a first input parameter.

Aspect 6. The method of any of Aspects 1 to 5, further comprising: calculating a plurality of sensitivity metrics that are each indicative of a rate of change of an output parameter relative to an input parameter; and identifying, based on the plurality of sensitivity metrics, one or more critical input parameters.

Aspect 7. The method of Aspect 6, further comprising: identifying, based on the plurality of sensitivity metrics, at least one negligible input; and simplifying the machine learning model by removing the at least one negligible input.

Aspect 8. A system comprising: one or more processors; and at least one computer-readable storage medium having stored therein instructions which, when executed by the one or more processors, cause the one or more processors to: determine a first value of a first output parameter during a first training iteration of a machine learning model; calculate a first sensitivity metric based on the first value of the first output parameter and one or more values of a first input parameter that are provided to the machine learning model during the first training iteration, wherein the first sensitivity metric is indicative of a rate of change of the first output parameter relative to the first input parameter; and determine, based on the first sensitivity metric, whether to continue training of the machine learning model.

Aspect 9. The system of Aspect 8, wherein the at least one computer-readable storage medium having stored therein instructions which, when executed by the one or more processors, further causes the one or more processors to: determine that the first sensitivity metric is greater than a threshold sensitivity value; and in response, determine to end the training of the machine learning model.

Aspect 10. The system of Aspect 8 or 9, wherein the at least one computer-readable storage medium having stored therein instructions which, when executed by the one or more processors, further causes the one or more processors to: determine a second value of the first output parameter during a second training iteration of the machine learning model; calculate a second sensitivity metric based on the second value of the first output parameter and the one or more values of the first input parameter that are provided to the machine learning model during the second training iteration; and determine, based on the first sensitivity metric and the second sensitivity metric, whether to continue the training of the machine learning model.

Aspect 11. The system of Aspect 10, wherein the at least one computer-readable storage medium having stored therein instructions which, when executed by the one or more processors, further causes the one or more processors to: determine that a deviation between the first sensitivity metric and the second sensitivity metric is greater than a threshold deviation value; and in response, determine to end the training of the machine learning model.

Aspect 12. The system of any of Aspects 8 to 11, wherein calculating the first sensitivity metric comprises: calculating a Jacobian matrix based on the first value of the first output parameter and the one or more values of a first input parameter.

Aspect 13. The system of any of Aspects 8 to 12, wherein the at least one computer-readable storage medium having stored therein instructions which, when executed by the one or more processors, further causes the one or more processors to: calculate a plurality of sensitivity metrics that are each indicative of a rate of change of an output parameter relative to an input parameter; and identify, based on the plurality of sensitivity metrics, one or more critical input parameters.

Aspect 14. The system of Aspect 13, wherein the at least one computer-readable storage medium having stored therein instructions which, when executed by the one or more processors, further causes the one or more processors to: identify, based on the plurality of sensitivity metrics, at least one negligible input; and simplify the machine learning model by removing the at least one negligible input.

Aspect 15. A non-transitory computer-readable storage medium comprising at least one instruction for causing a computer or processor to: determine a first value of a first output parameter during a first training iteration of a machine learning model; calculate a first sensitivity metric based on the first value of the first output parameter and one or more values of a first input parameter that are provided to the machine learning model during the first training iteration, wherein the first sensitivity metric is indicative of a rate of change of the first output parameter relative to the first input parameter; and determine, based on the first sensitivity metric, whether to continue training of the machine learning model.

Aspect 16. The non-transitory computer-readable storage medium of Aspect 15, comprising at least one instruction for further causing a computer or processor to: determine that the first sensitivity metric is greater than a threshold sensitivity value; and in response, determine to end the training of the machine learning model.

Aspect 17. The non-transitory computer-readable storage medium of Aspect 15 or 16, comprising at least one instruction for further causing a computer or processor to: determine a second value of the first output parameter during a second training iteration of the machine learning model; calculate a second sensitivity metric based on the second value of the first output parameter and the one or more values of the first input parameter that are provided to the machine learning model during the second training iteration; and determine, based on the first sensitivity metric and the second sensitivity metric, whether to continue the training of the machine learning model.

Aspect 18. The non-transitory computer-readable storage medium of Aspect 17, comprising at least one instruction for further causing a computer or processor to: determine that a deviation between the first sensitivity metric and the second sensitivity metric is greater than a threshold deviation value; and in response, determine to end the training of the machine learning model.

Aspect 19. The non-transitory computer-readable storage medium of any of Aspects 15 to 18, wherein calculating the first sensitivity metric comprises: calculating a Jacobian matrix based on the first value of the first output parameter and the one or more values of a first input parameter.

Aspect 20. The non-transitory computer-readable storage medium of any of Aspects 15 to 19, comprising at least one instruction for further causing a computer or processor to: calculate a plurality of sensitivity metrics that are each indicative of a rate of change of an output parameter relative to an input parameter; and identify, based on the plurality of sensitivity metrics, one or more critical input parameters.

What is claimed is:

1. A method comprising:
determining a first value of a first output parameter during a first training iteration of a machine learning model;
calculating a first sensitivity metric based on the first value of the first output parameter and one or more values of a first input parameter that are provided to the machine learning model during the first training iteration, wherein the first sensitivity metric is indicative of a rate of change of the first output parameter relative to the first input parameter; and
determining, based on the first sensitivity metric, whether to continue training of the machine learning model.

2. The method of claim 1, further comprising:
determining that the first sensitivity metric is greater than a threshold sensitivity value; and
in response, determining to end the training of the machine learning model.

3. The method of claim 1, further comprising:
determining a second value of the first output parameter during a second training iteration of the machine learning model;
calculating a second sensitivity metric based on the second value of the first output parameter and the one or more values of the first input parameter that are provided to the machine learning model during the second training iteration; and
determining, based on the first sensitivity metric and the second sensitivity metric, whether to continue the training of the machine learning model.

4. The method of claim 3, further comprising:
determining that a deviation between the first sensitivity metric and the second sensitivity metric is greater than a threshold deviation value; and
in response, determining to end the training of the machine learning model.

5. The method of claim 1, wherein calculating the first sensitivity metric comprises:
calculating a Jacobian matrix based on the first value of the first output parameter and the one or more values of a first input parameter.

6. The method of claim 1, further comprising:
calculating a plurality of sensitivity metrics that are each indicative of a rate of change of an output parameter relative to an input parameter; and
identifying, based on the plurality of sensitivity metrics, one or more critical input parameters.

7. The method of claim 6, further comprising:
identifying, based on the plurality of sensitivity metrics, at least one negligible input; and
simplifying the machine learning model by removing the at least one negligible input.

8. A system comprising:
one or more processors; and
at least one computer-readable storage medium having stored therein instructions which, when executed by the one or more processors, cause the one or more processors to:
determine a first value of a first output parameter during a first training iteration of a machine learning model;
calculate a first sensitivity metric based on the first value of the first output parameter and one or more values of a first input parameter that are provided to the machine learning model during the first training iteration, wherein the first sensitivity metric is indicative of a rate of change of the first output parameter relative to the first input parameter; and
determine, based on the first sensitivity metric, whether to continue training of the machine learning model.

9. The system of claim 8, wherein the at least one computer-readable storage medium having stored therein instructions which, when executed by the one or more processors, further causes the one or more processors to:
determine that the first sensitivity metric is greater than a threshold sensitivity value; and
in response, determine to end the training of the machine learning model.

10. The system of claim 8, wherein the at least one computer-readable storage medium having stored therein instructions which, when executed by the one or more processors, further causes the one or more processors to:
determine a second value of the first output parameter during a second training iteration of the machine learning model;
calculate a second sensitivity metric based on the second value of the first output parameter and the one or more values of the first input parameter that are provided to the machine learning model during the second training iteration; and
determine, based on the first sensitivity metric and the second sensitivity metric, whether to continue the training of the machine learning model.

11. The system of claim 10, wherein the at least one computer-readable storage medium having stored therein instructions which, when executed by the one or more processors, further causes the one or more processors to:
determine that a deviation between the first sensitivity metric and the second sensitivity metric is greater than a threshold deviation value; and
in response, determine to end the training of the machine learning model.

12. The system of claim 8, wherein calculating the first sensitivity metric comprises:
calculating a Jacobian matrix based on the first value of the first output parameter and the one or more values of a first input parameter.

13. The system of claim 8, wherein the at least one computer-readable storage medium having stored therein instructions which, when executed by the one or more processors, further causes the one or more processors to:
calculate a plurality of sensitivity metrics that are each indicative of a rate of change of an output parameter relative to an input parameter; and
identify, based on the plurality of sensitivity metrics, one or more critical input parameters.

14. The system of claim 13, wherein the at least one computer-readable storage medium having stored therein instructions which, when executed by the one or more processors, further causes the one or more processors to:
identify, based on the plurality of sensitivity metrics, at least one negligible input; and
simplify the machine learning model by removing the at least one negligible input.

15. A non-transitory computer-readable storage medium comprising at least one instruction for causing a computer or processor to:
determine a first value of a first output parameter during a first training iteration of a machine learning model;
calculate a first sensitivity metric based on the first value of the first output parameter and one or more values of a first input parameter that are provided to the machine learning model during the first training iteration, wherein the first sensitivity metric is indicative of a rate of change of the first output parameter relative to the first input parameter; and
determine, based on the first sensitivity metric, whether to continue training of the machine learning model.

16. The non-transitory computer-readable storage medium of claim 15 comprising at least one instruction for further causing a computer or processor to:
determine that the first sensitivity metric is greater than a threshold sensitivity value; and
in response, determine to end the training of the machine learning model.

17. The non-transitory computer-readable storage medium of claim 15, comprising at least one instruction for further causing a computer or processor to:
determine a second value of the first output parameter during a second training iteration of the machine learning model;
calculate a second sensitivity metric based on the second value of the first output parameter and the one or more values of the first input parameter that are provided to the machine learning model during the second training iteration; and
determine, based on the first sensitivity metric and the second sensitivity metric, whether to continue the training of the machine learning model.

18. The non-transitory computer-readable storage medium of claim 17, comprising at least one instruction for further causing a computer or processor to:
determine that a deviation between the first sensitivity metric and the second sensitivity metric is greater than a threshold deviation value; and
in response, determine to end the training of the machine learning model.

19. The non-transitory computer-readable storage medium of claim 15, wherein calculating the first sensitivity metric comprises:
calculating a Jacobian matrix based on the first value of the first output parameter and the one or more values of a first input parameter.

20. The non-transitory computer-readable storage medium of claim 15, comprising at least one instruction for further causing a computer or processor to:
calculate a plurality of sensitivity metrics that are each indicative of a rate of change of an output parameter relative to an input parameter; and
identify, based on the plurality of sensitivity metrics, one or more critical input parameters.
